(19) United States
(12) Patent Application Publication
(10) Pub. No.: US 2025/0220506 A1
(43) Pub. Date: Jul. 3, 2025

(54) METHODS AND DISTRIBUTED UNITS

(71) Applicant: Sony Group Corporation, Tokyo (JP)

(72) Inventors: Vivek SHARMA, Basingstoke (GB); Hideji WAKABAYASHI, Basingstoke (GB); Yassin Aden AWAD, Basingstoke (GB); Yuxin WEI, Basingstoke (GB)

(73) Assignee: Sony Group Corporation, Tokyo (JP)

(21) Appl. No.: 18/848,226

(22) PCT Filed: Feb. 24, 2023
(86) PCT No.: PCT/EP2023/054739

§ 371 Date: Sep. 18, 2024

(30) Foreign Application Priority Data
Mar. 30, 2022 (EP) 22165697.8

(51) Int. Cl. H04W 28/08; H04W 24/10; H04W 52/02

(52) U.S. Cl. CPC H04W 28/08; H04W 24/10; H04W 52/0235

(57) ABSTRACT

A method of controlling a distributed unit, DU, connected to a central unit, CU, of a wireless communications network is provided. The method comprises receiving, from another DU connected to the CU, information for controlling communications with a communications device controlled by the DU. The information for controlling communications with the communications device being received over an air interface connecting the DU and the other DU. The method comprises controlling communications with the communications device based on the information for controlling communications with the communications device received over the air interface. The controlling the communications with the communications device comprises executing one or more control functions including at least a radio resource management, RRM, function.

### BACKGROUND

### Field of Disclosure

The present disclosure relates to distributed units and methods of controlling a distributed unit, DU, connected to a central unit, CU, of a wireless communications network.

The present application claims the Paris Convention priority of European patent application number EP 22165697.8, the contents of which are hereby incorporated by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Future wireless communications networks will be expected routinely and efficiently to support communications with an ever-increasing range of devices associated with a wider range of data traffic profiles and types than existing systems are optimised to support. For example, it is expected future wireless communications networks will be expected efficiently to support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

### SUMMARY OF THE DISCLOSURE

The present disclosure can help address or mitigate at least some of the issues discussed above.

Embodiments of the present technique can provide a method of controlling a distributed unit, DU, connected to a central unit, CU, of a wireless communications network. The method comprises receiving, from another DU connected to the CU, information for controlling communications with a communications device controlled by the DU. The information for controlling communications with the communications device is received over an air interface connecting the DU and the other DU. The method comprises controlling communications with the communications device based on the information for controlling communications with the communications device received over the air interface. The controlling the communications with the communications device comprises executing one or more control functions including at least a radio resource management, RRM, function.

As will be understood more fully with reference to the following description, example embodiments can provide an air interface between separate DUs for exchanging information for controlling communications with the communications device (alternatively referred to as “control information”). The control information may include for managing interference between the communications device and one or more other communications devices controlled by the other DU. The control information may include information for communications resource management. The control information may include information regarding cell mobility. Therefore. example embodiments can more efficiently manage inter-cell interference, communications resources and inter-cell mobility.

According to embodiments of the present technique, there is provided another method of controlling a distributed unit, DU, connected to a central unit, CU, of a wireless communications network. The method comprises receiving a control message from CU. The control message includes a part of a radio resource control, RRC, message for transmission to a communications device. The method comprises executing an RRC function based on the control message to include a remaining part of the RRC message in the control message. The part of the RRC message in the control message received from the CU and the remaining part of the RRC message included by the DU in the control message form a completed RRC message in the control message. The method comprises forwarding the control message including the completed RRC message to the communications device.

According to embodiments of the present technique, there is provided a method of controlling a distributed unit, DU, connected to a central unit, CU, of a wireless communications network. The method comprises receiving, from a communications device controlled by the DU, a control message including a Radio Resource Control, RRC, message. The method comprises executing an RRC function based on the control message to extract a part of the RRC message from the control message. The method comprises forwarding the control message to the CU for the CU to extract a remaining part of the RRC message from the control message.

As will be understood more fully with reference to the following description. example embodiments can provide reduced latency communications in a wireless communications network. According to example embodiments, control functions (such as RRC functions) which would conventionally be performed in a CU can be performed in the DU and the CU in co-operation to reduce the number of message exchanges between a CU and DU when controlling communications of a communications device.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of a new radio access technology (RAT) wireless communications system which may be configured to operate in accordance with certain embodiments of the present disclosure;

FIG. 2 is a schematic block diagram of an example infrastructure equipment and communications device which may be configured to operate in accordance with certain embodiments of the present disclosure;

FIG. 3A is a representation of a gNB DU and a gNB CU communicating via an F1 interface;

FIG. 3B is a schematic representation of a protocol stack operated respectively by the gNB DU and gNB CU shown in FIG. 3A for communicating control plane data;

FIG. 3C is a schematic representation of a protocol stack operated respectively by the gNB DU and gNB CU shown in FIG. 3A for communicating user plane data;

FIG. 4 schematically illustrates a split of gNB functionality between a CU-CP, CU-UP and the DU according to current architecture;

FIG. 5 shows a flow diagram illustrating a method of controlling a DU according to example embodiments;

FIG. 6 schematically illustrates an improved allocation of gNB functions in a CU and a DU according to example embodiments;

FIG. 7 schematically illustrates an improved allocation of gNB functions in a CU and a DU for a plurality of communications devices according to example embodiments;

FIG. 8A is a representation of a first DU and a second DU communicating via an air interface;

FIG. 8B is a representation of a protocol stack operated respectively by the first DU and the second DU shown in FIG. 8A for communicating control plane data according to example embodiments;

FIG. 8C is a schematic representation of a protocol stack operated respectively by the first DU and the second DU shown in FIG. 8A for communicating user plane data according to example embodiments.

### DETAILED DESCRIPTION OF THE EMBODIMENTS

### New Radio Access Technology (5G)

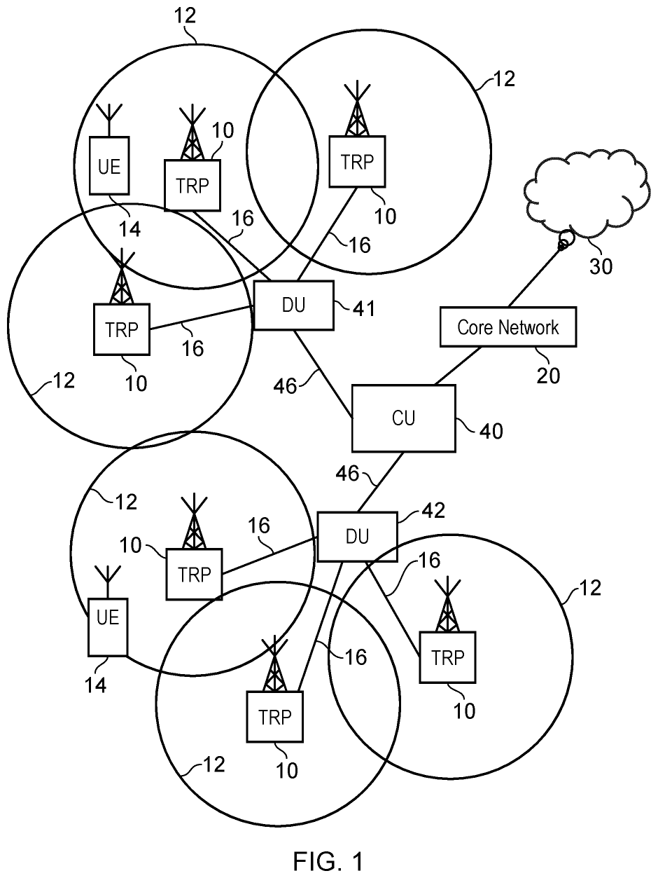

An example configuration of a wireless communications network which uses some of the terminology proposed for and used in NR and 5G is shown in FIG. 1. In FIG. 1 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12.

As such, wireless communications devices 14 which are within a radio communications range provided by the cells 12 can transmit and receive signals to and from the TRPs 10 via the wireless access interface. Each of the distributed units 41. 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

As will be appreciated by those acquainted with the wireless communications network according to 5G standard shown in FIG. 1, the CU 40. DU 42 and TRPs 10 collectively perform functions which are conventionally performed by a network base station or, in accordance with 5G terminology, a gNB. Accordingly, the terms CU and DU may be respectively referred to as a “gNB-CU” and a “gNB-DU” when it is appropriate to emphasise that the CU and the DU form part of a gNB.

The TRPs 10 of FIG. 1 may in part have a corresponding functionality to a base station or eNodeB of an LTE network. Similarly, the communications devices 14 may be referred to mobile terminals, terminals or user equipment (UE), which encompasses chip sets and have a functionality corresponding to the UE devices known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the term network infrastructure equipment/access node may be used to encompass these elements and more conventional base station type elements of wireless telecommunications systems.

Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 1 within the coverage area of the first communication cell 12. This communications device 14 may thus exchange signalling with the first CU 40 in the first communication cell 12 via one of the distributed units/TRPs 10 associated with the first communication cell 12.

It will further be appreciated that FIG. 1 represents merely one example of a proposed architecture for a new RAT based telecommunications system in which approaches in accordance with the principles described herein may be adopted, and the functionality disclosed herein may also be applied in respect of wireless telecommunications systems having different architectures.

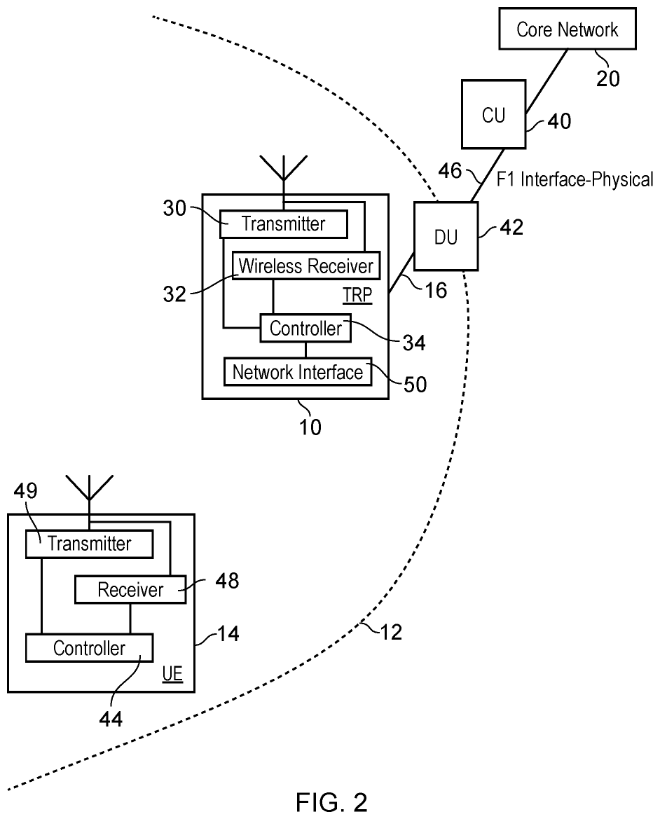

FIG. 2 provides a more detailed diagram of some of the components of the network shown in FIG. 1. In FIG. 2, a TRP 10 as shown in FIG. 1 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 2, an example communications device 14 (such as a UE) is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc. configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 2 as separate elements for case of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 2, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications [1] and [2], and may be formed from a fibre optic or other wired or wireless high bandwidth connection. In one example the connection 16 from the TRP 10 to the DU 42 is via fibre 15 optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

As will be appreciated by those acquainted with 5G architecture, the CU 40 a logical node which hosts 20 Radio Resource Control (RRC) protocols. Service Data Adaptation Protocols (SDAP) and Packet Data Convergence Protocols (PDCP) of a gNB. Alternatively, the CU 40 is a logical node which hosts RRC and PDCP protocols of an en-gNB (which can be understood as being, for example, a secondary node (SgNB) used in dual connectivity scenarios). The CU 40 partly controls the operation of one or more DUs 40 and terminates the F1 interface 46 for the DUs that it controls.

The DU 42 a logical node which hosts Radio Link Control (RLC), Medium Access Control (MAC) and Physical (PHY) layers of a gNB or en-gNB. The operation of the DU 42 is partly controlled by the CU 40 for which the DU 42 terminates the F1 interface 46.

30 Although not shown in FIG. 1 or 2, it will be familiar to those acquainted with 5G architecture that the CU 40 may be further split into a CU-CP which performs the control plane functions of the CU 40 and a CU-UP which performs the user plane functions of the CU 40 (see for example, [3]). In more detail the CU-CP is a logical node hosting an RRC protocol and a control plane part of a PDCP protocol of the CU 40 for the gNB or en-gNB. The CU-CP terminates an E1 interface connected with the CU-UP and an F1-C interface connected with the DU 42. As will be appreciated, the F1-C interface carries control plane signalling of the F1 interface 46.

The CU-UP is a logical node which hosts a user plane part of a PDCP protocol of the CU 40 for an en-gNB. Alternatively, the CU-UP is a logical node which hosts a user plane part of the PDCP protocol and an SDAP protocol of the CU 40 for a gNB. The CU-UP terminates an E1 interface connected with the CU-CP and an F1-U interface connected with the DU 42. As will be appreciated, the F1-U interface carries user plane signalling of the F1 interface 46.

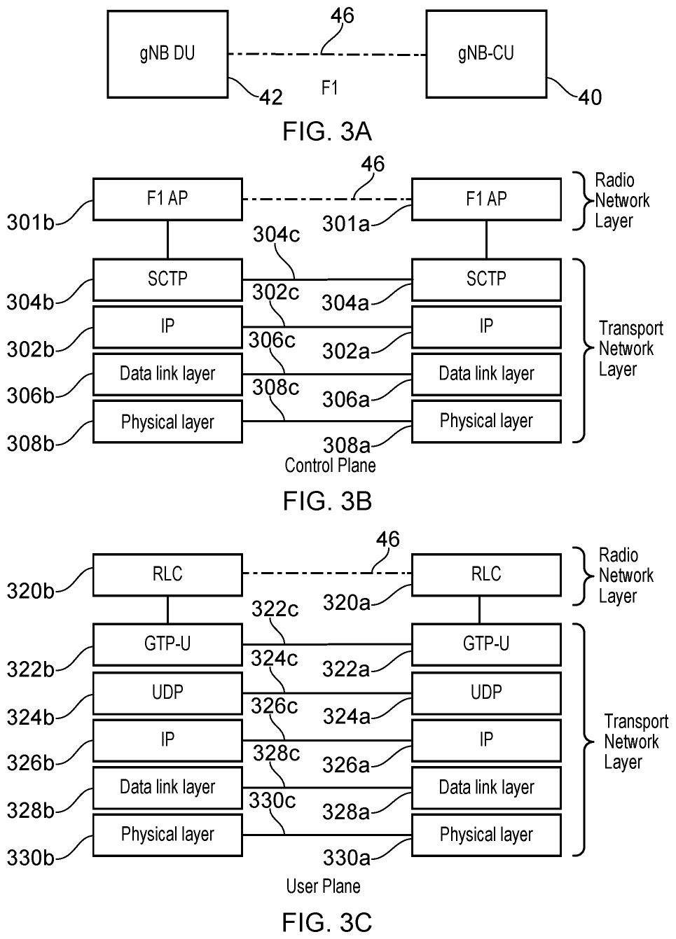

In order to appreciate example embodiments, a protocol stack for forming a conventional F1 interface 45 shown in FIGS. 1 and 2 will be explained with reference to FIG. 3.

In respect of a protocol stack. FIGS. 3A. B and C provide an illustration of processing performed by the elements shown in FIGS. 1 and 2 which form the packet data communications path 46 between the gNB-DU 42 and the gNB-CU 40 via the F1 interface 46. Control plane communications are considered separately to user plane data although in practice they form the same interface and are processed and transmitted by the same hardware equipment. As shown in FIG. 3A communication is formed between the gNB DU 42 and a gNB CU 40 for the F1 interface 46. However, the control plane protocol stack to form this interface is shown in FIG. 3B, and the user plane protocol stack for communicating the user data between the gNB-CU 40 and gNB-DU 42 is shown in FIG. 3C. As shown in FIG. 3B at the radio network layer, the control plane is formed by F1 Application Protocols (APs) 301a in the gNB-CU 40 and by F1 APs 301b in the gNB DU 42. As will be understood by those acquainted with the 5G Architecture, communication between a gNB-CU and a gNB DU is by IPV 6 or IPv4 Internet protocols as specified in [4]. This is shown in FIG. 3B as an IP layer 302a in the gNB-CU 40 and an IP layer 302b in the gNB-DU 42 forming an IP communication interface 302c. A Stream Control Transmission Protocol (SCTP) layer of the protocol stack 304a, 304b, 304c controls end to end communication via the IP layer 302 including flow control and quality of service. The IP data is communicated between the gNB DU and gNB CU via logical data link layer 306a, 306b, 306c and the physical layer 308a, 308b, 308c.

In the user plane, the radio network layer is formed by RLC layer 320a, 320b to form the F1 interface for communicating use plane data 46. The protocol stack in the transport layer comprises a GPRS Tunnelling Protocol for user plane data (GTP-U) 322a, 322b, 322c, which controls communication of user plane data for roaming and home subscribers via a UDP layer 324a, 324b, 324c which controls communication of user plane data via an IP layer 326a, 326b, 326c. As with the control plane, the IP data is communicated between the gNB DU and gNB CU via logical data link layer 328a, 328b, 328c and the physical layer 330a, 330b, 330c.

### CU-DU Split Functions

As indicated above, the CU 40 and DU 42 are configured to execute gNB functionality. The allocation or splitting of gNB functions between the CU 40 and the DU 42 is discussed in [5]. Such gNB functions include:
(i) Functions for Radio Resource Management; Radio Bearer Control, Radio Admission Control, Connection Mobility Control, Dynamic allocation of resources to UEs in both uplink and downlink (scheduling);
(ii) IP and Ethernet header compression, encryption and integrity protection of data;
(iii) Selection of an Access and Mobility Management Function (AMF) at UE attachment when no routing to an AMF can be determined from the information provided by the UE;
(iv) Routing of User Plane data towards User Plane Functions (UPFs);
(v) Routing of Control Plane information towards AMF;
(vi) Connection setup and release;
(vii) Scheduling and transmission of paging messages;
(viii) Scheduling and transmission of system broadcast information (originated from the AMF or OAM);
(ix) Measurement and measurement reporting configuration for mobility and scheduling;
(x) Transport level packet marking in the uplink;
(xi) Session Management;
(xii) Support of Network Slicing;
(xii) QoS Flow management and mapping to data radio bearers;
(xiv) Support of UEs in RRC_INACTIVE state;
(xv) Distribution function for NAS messages;
(xvi) Radio access network sharing;
(xvii) Dual Connectivity;
(xviii) Tight interworking between NR and E-UTRA;
(xix) Maintain security and radio configuration for User Plane CloT 5GS Optimisation, as defined in [6] (ng-eNB only).

Functions (i) to (xviii) can be performed by gNBs and ng-eNBs whereas function (xix) is performed by ng-eNBs only. Furthermore, bandwidth reduced low complexity (BL) UEs or UEs in enhanced coverage are only supported by ng-eNB (see for example, [7]). Additionally, NB-IoT UE is only supported by ng-eNB (see for example, [7]).

As will be appreciated, 5G networks are currently deployed in millimetre wave band. However, due to the higher communication bandwidths that can be achieved at higher frequencies, there is an increased demand for wireless communications at higher frequencies in 5G networks. The use of higher frequencies in wireless communications leads to increased pathloss and therefore smaller cell sizes than if lower frequencies were used. As a result, in order to achieve suitable coverage, a dense deployment of networks may be required.

A dense deployment of networks creates a number of technical challenges for the current 5G architecture as explained with reference to FIGS. 1 and 2. For example, as mentioned previously, the DU 42 and the CU 40 may be connected over a wired connection 46 such as fibre optic. Therefore, a dense deployment of networks may increase the number of required wired connections which may not always be possible. Furthermore, the use of wired connections 46 between the CU 40 and the DU may lead to increased latency due to current topology designs. For example, as will be appreciated from FIG. 1, two DUs 41, 42 are connected to the CU 40 via wired connections 46 in a “tree topology”. Therefore, if any direct signalling is required between two cells 12 (for example, one cell provided by DU 41 and one cell provided by DU 42) then such signalling must propagate via the CU 40. This can lead to congestion and increased latency especially when a large number of cells are deployed in close proximity, such as in dense deployment scenarios.

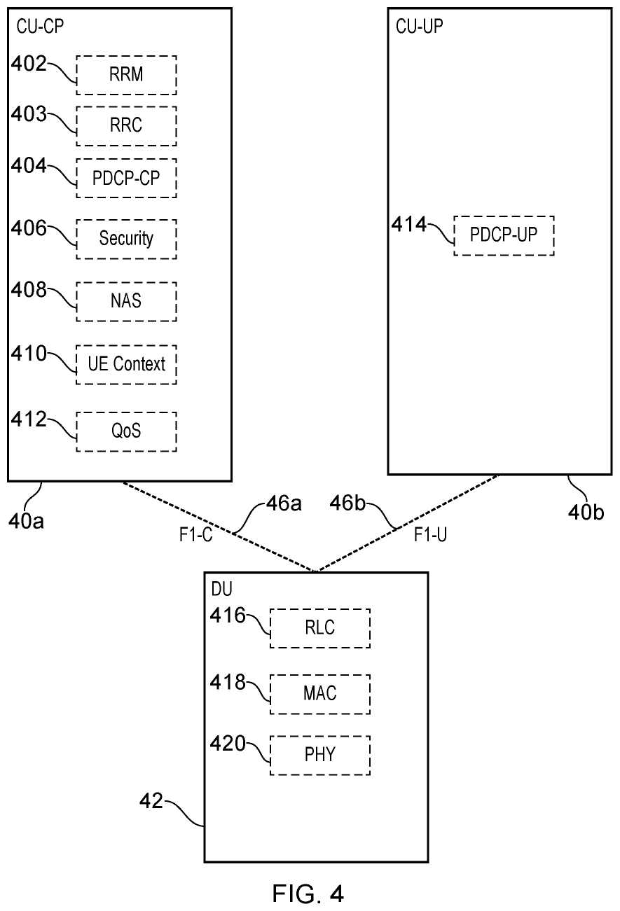

Furthermore, as will be explained in more detail with reference to FIG. 4, a higher cell density creates technical challenges in providing cell mobility and interference management. FIG. 4 illustrates a split of gNB functionality between a CU-CP 40a, CU-UP 40b and the DU 42 according to current 5G architectures. The CU-CP 40a and CU-UP 40b are logical nodes which perform the functions of the CU 40 described with reference to FIGS. 1, 2 and 3. As shown in FIG. 4, the CU-CP 40a is configured to perform radio resource management (RRM) functions 402. Radio Resource Control (RRC) functions 403, Packet Data Convergence Protocol Control Plane (PDCP-CP) functions 404. Security functions 406. Non-Access Stratum (NAS) functions 408, user equipment (UE) context functions 410, and Quality of Service (QOS) functions 412. The CU-UP 40b is configured to perform Packet Data Convergent Protocol User Plane (PDCP-UP) functions 414. The DU 42 is configured to perform RLC functions 416, MAC functions 418. PHY functions 420. As will be appreciated, a scheduler in the DU 42 may be implemented based on the guidelines as mentioned in section 10 of 38.300 [5].

Typically, interface management is performed by adjusting communications resources in the time. frequency and/or spatial domain. Further, if communications resources are constrained, then there a number of ways, apart from adjusting resources in time/frequency/spatial domain, to adapt a radio bearer to reduce inter-cell interference such as increasing latency (but maintaining reliability) by skipping the scheduling the radio bearer for a time period. Alternatively, inter-cell interference may be reduced by reducing the data rate of the radio bearer.

Interference management performed by a CU is referred to as “centralised interference management”. However, “distributed interference management” performed by a DU is also possible. Recently, hybrid interference management has been developed [8] which comprises a mix of centralised and distributed interference management. For example, centralised interference management may be performed in the licensed spectrum in the coverage of a macro cell and distributed interference management may be performed where macro cell coverage is poor. However, current distributed interference management schemes are limited to managing interference for the cells controlled by the DU, and there is currently no mechanism for managing inter-cell interference between cells of different DUs without resorting to centralised interference management.

Furthermore, the current architectures suffer from high latency communications when a CU controls a communications device through a DU. For example, a CU may determine to change a configuration based on some logic such as a measurement report received from a UE on the uplink. In response, the CU sends an F1 message to a DU to prepare a new configuration for RLC. MAC and/or PHY. In response to receiving the F1 message, the DU responds to the CU with the new RLC. MAC and/or PHY configuration. Then, the CU packs the new RLC. MAC and/or PHY configuration into a control message along with another configuration which has been prepared by the CU itself. The CU transmits the control message including the RLC. MAC and/or PHY configuration prepared by the DU and the other configuration prepared by the CU to the UE via the DU. Therefore, as will be appreciated, current architectures require several message flows between a CU and a DU. Interference coordination is one example where such coordination between CU and DU involves multiple iteration of messages. However, this is true for configuration/reconfiguration related to any feature which invoke different functions residing in CU and DU, as shown in FIG. 4, where a coordination is required before sending the final RRC message to a UE.

There is therefore a need for wireless communications networks which can more efficiently control communications of a communications device. For example, there is a need for improved management of inter-cell interference and cell mobility. Furthermore, there is a need for reduced latency communications when controlling communications with a communications device.

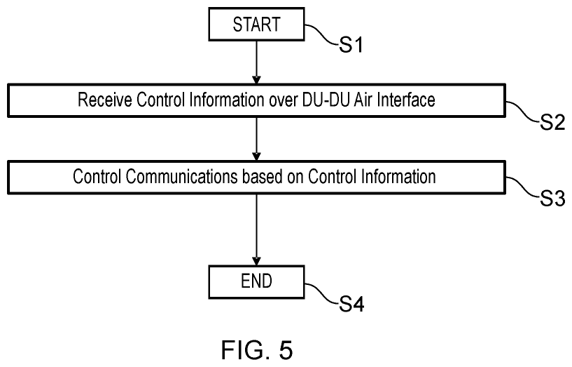

In view of the above, there is provided a method of controlling a distributed unit, DU, connected to a central unit, CU, of a wireless communications network as shown in FIG. 5. The method starts at step S1. After step S1, in step S2, the DU receives, from another DU connected to the CU, information for controlling communications with the communications device controlled by the DU. The communications device may be located in a cell provided by a TRP controlled by the DU. Furthermore, references to a communications device being controlled by a DU do not necessarily mean that the communications device solely controlled by the DU, but may be controlled by the DU in combination with the CU to which the DU is connected. The connection between the DU and the CU may be a physical and/or logical connection. Similarly, the connection between the other DU and the CU may be a physical and/or logical connection. The information for controlling communications with the communications device may also be referred to as “control information”. The control information includes any information suitable to be used for controlling communications with the communications device. For example, the control information may include information about a communications resource allocation for one or more other communications devices controlled by the other DU. The control information may include information about a transmission power used for transmissions to, or transmissions by, the one or more other communications devices, measurement reports from the one or more other communications devices. In some embodiments, the control information may include instructions from the other DU such as an instruction to allocate particular communications resources for the communications device and/or to use a particular transmission power for transmissions to, or transmissions by, the communications device. The control information is received over an air interface connecting the DU and the other DU. In other words, the DU and other DU can be separate units which can exchange interference management over the air.

After step S2, in step S3, the DU controls communications with the communications device based on the information for controlling communications with the communications device received over the air interface. For example, the DU may determine a communications resource allocation and/or transmission power for transmissions to, or transmissions by, the communications device based on the control information. The controlling the communications with the communications device comprises executing one or more control functions including at least a radio resource management, RRM, function. The one or more control functions may additionally comprise a Radio Resource Control, RRC, function and/or a security function. The execution of a function may be alternatively referred to as the performance of a function. The execution of a control function may be understood as processing a signal according to the function. For example, the execution of an RRC function may comprise executing one or more RRC protocols as will be appreciated by one skilled in the art. The one or more control functions can therefore provide for the exchange of control information over the air interface between the DU and the other DU. The one or more control functions enable the DU to understand and process control information without necessarily having to contact the CU. The method ends in step S4.

According to some example embodiments, there is provided a method of controlling a distributed unit, DU, connected to a central unit, CU, of a wireless communications network. The method comprises receiving a control message from CU. The control message includes a part of a radio resource control, RRC, message for transmission to a communications device. The method comprises executing an RRC function based on the control message to include a remaining part of the RRC message in the control message. The part of the RRC message in the control message received from the CU and the remaining part of the RRC message included by the DU in the control message form a completed RRC message in the control message. The method comprises forwarding the control message including the completed RRC message to the communications device. The execution of the RRC function to include the remaining part of the RRC message in the control message may alternatively be referred to as “filling in” a part of the RRC message as will be appreciated by one skilled in the art. The part of the RRC message included in the control message received from the CU may have been included in the control message by the CU.

According to some example embodiments, there is provided a method of controlling a distributed unit, DU, connected to a central unit, CU, of a wireless communications network. The method comprises receiving, from a communications device controlled by the DU, a control message including a Radio Resource Control, RRC, message. The method comprises executing an RRC function based on the control message to extract a part of the RRC message from the control message. The method comprises forwarding the control message to the CU for the CU to extract a remaining part of the RRC message from the control message.

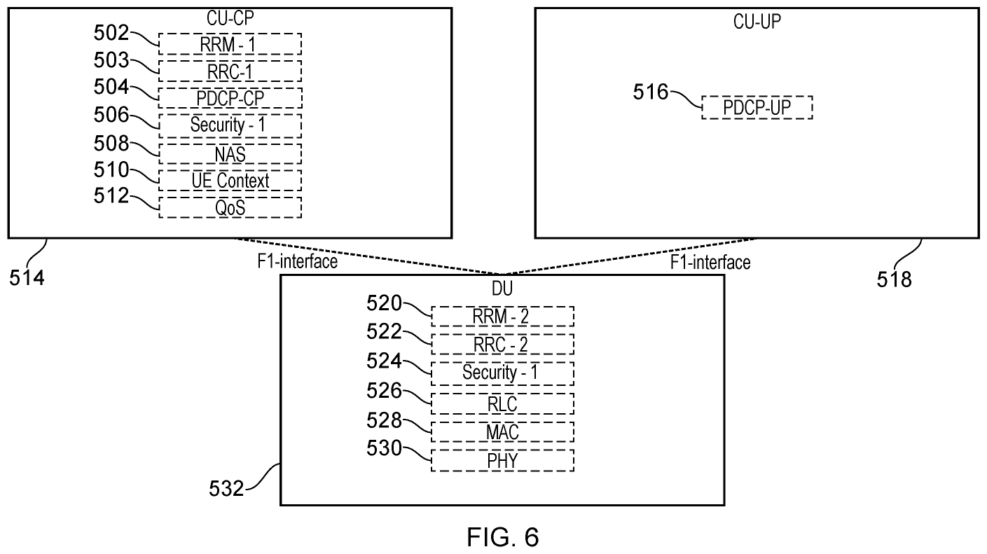

FIG. 6 schematically illustrates an improved allocation of gNB functions in a CU and a DU according to example embodiments. As shown in FIG. 6, a CU-CP 514 is configured to perform a set of functions including RRM-1 functions 502, RRC-1 functions 503. PDCP-CP functions 504. Security-1 functions 506. NAS functions 508. UE context functions 510 and QoS functions 512. A CU-UP 518 is configured to perform PDCP-UP functions 516. A DU is configured to perform a set of functions RRM-2 functions 520, RRC-2 functions 522. Security-2 functions 524, RLC functions 526, MAC functions 528 and PHY functions 530. The RRM-1 functions 502 and the RRM-2 functions 520 may each represent a sub-set of the RRM functions 402 in CU-CP 40a. In other words, the RRM functions 402 are split into RRM-1functions 502 and the RRM-2 functions 520. with the RRM-1 functions 502 being performed by the CU-CP 514 and the RRM-2 functions 520 being performed by the DU 532. Similarly, the RRC-1 functions 503 and the RRC-2 functions 522 may each represent a sub-set of the RRC functions 403 in CU-CP 40a. In other words, the RRC functions 403 are split into RRC-1 functions 503 and the RRC-2 functions 522. with the RRC-1 functions 503 being performed by the CU-CP 514 and the RRC-2 functions 522 being performed by the DU 532. Similarly, the Security-1 functions 506 and the Security-2 functions 524 may each represent a sub-set of the Security functions 406 in CU-CP 40a. In other words, the Security functions 406 are split into the Security-1 functions 506 and the Security-2 functions 524, with the Security-1 functions 506 being performed by the CU-CP 514 and the Security-2 functions 524 being performed by the DU 532.

The RRM-1 functions 502, the RRC-1 functions 503 and the security functions 506 may be configured to enable the CU-CP 514 to perform gNB functions (i), (iii), (v), (vi), (ix) and (xi) to (xix) mentioned above.

As will be explained in more detail below, the splitting of RRM functions between the CU-CP 514 and the DU 532 can enable a more efficient management of communications resources. The splitting of RRC functions CU-CP 514 and the DU 532 may enable reduced latency communications by reducing message exchanges between the CU-CP 514 and the DU 532. The splitting of security functions between the CU-CP 514 and the DU 532 can provide improved security communications between the CU-CP 514 and the DU 532, or between two DUs over an air interface as will be explained in more detail below.

In some embodiments the RRM-1 functions 502, RRC-1 functions 503. Security-1 functions 506 are “master” functions and the RRM-2 functions 520, RRC-2 functions 522. Security-2 functions 524 are “secondary functions”. For example, if the RRM-1 functions 502 are master functions of the secondary RRM-2 functions 520, then overall RRM control may lie with the RRM-1 functions 502. Similarly, if the RRC-1 functions 503 are master functions of the secondary RRC-2 functions 522, then overall RRC control may lie with the RRC-1 functions 503. Similarly, if the Security functions 506 are master functions of the secondary Security-2 functions 524, then overall security control may lie with the Security-1 functions 506. In some embodiments, the secondary functions may be configured to perform a subset of the master functions. In some embodiments, the secondary functions may perform actions based on input received from the master functions. In some embodiments, if the secondary functions determine to take action independently of the master functions, then the secondary functions may notify the master functions before taking action.

In embodiments where the Security-1 functions 506 are master functions of the secondary Secruity-2 functions 524, the Security-2 functions 506 may implement a blockchain security method whereas the Security-1 functions 524 may implement legacy 3GPP security methods.

The NAS functions 508, the UE context functions 510 and the QoS functions 512 performed by the CU-CP-514 may broadly correspond to the NAS functions 408, the UE context functions 410 and the QoS functions 412 performed by the CU-CP 40a. The PDCP-UP functions 516 in the CU-UP 518 may broadly correspond to the PDCP functions-UP 414 in the CU-UP 40b. The RLC functions 526, the MAC functions 528 and the PHY functions 530 performed by the DU 532 may broadly correspond to the RLC functions 416, the MAC functions 418 and the PHY functions 420 performed by the DU 42.

As will be appreciated, the above allocation of gNB functions among the CU-CP 514 and the DU 532 provides a delegation of at least some CU functionality to a DU. The delegation of RRC functions to a DU may reduce the number of exchanges between a CU and a DU required to control communications with a communications device such as when a configuration change is required. For example, in accordance with example embodiments, the CU-CP 514 may determine to change a configuration. For example, the CU-CP 514 may determine to change a configuration based on a measurement report received from a UE via the DU 532. Therefore the CU-CP 514 prepares a control message for transmission to the UE via the DU 532. In preparing the control message, the CU-CP 514 executes the RRC-1 functions 503 to include a part of an RRC message (such as an RRC reconfiguration message) in the control message. The preparation of the control message may include allocating a space in the control message for the DU 532 to include a remaining part of the RRC message and for the DU 532 to include its own RLC. MAC and/or PHY configuration. Then, the prepared control message is transmitted from the CU-CP 514 to the DU 532 as an F1-AP message. In response, the DU 532 executes the RRC-2 functions 522 based on the received control message to include the remaining part of the RRC message in the control message. The part of the RRC message included by the CU-CP 514 and the remaining part of the control message included by the DU 532 together form a completed RRC message. Also, the DU 532 includes its RLC, MAC and/or PHY configuration in the control message. The DU 532 then forwards the control message towards the UE. In some embodiments, the DU 532 may transmit an acknowledgement to the CU-CP 514 that the control message was forwarded onto the UE.

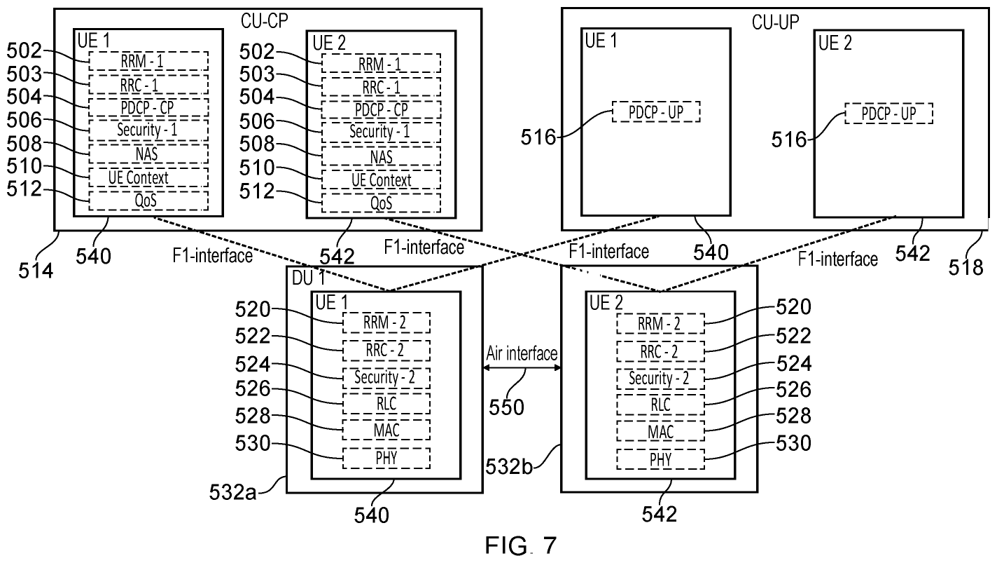

Although the above example embodiment has been described for the transmission of a downlink control message from the CU-CP 514 to a UE. example embodiments can be applied to an uplink control message transmitted from the UE to the CU-CP 514. For example, the DU 532 may receive a control message from the UE for transmission to the CU-CP 514. In one example, the control message may include an RRC message such as a measurement report. The DU 532 may execute the RRC-2 functions 522 based on the RRC message to extract a part of the RRC message. Based on the extracted part of the RRC message, the DU 532 may determine that it can respond to the UE directly. For example, the DU 532 may prepare a configuration (such as a measurement configuration) based on the control message and transmit the configuration to the UE or use this information in RRM-2 522 or exchange this information with another DU 542 in FIG. 7. The DU 532 may determine that the control message should be forwarded to the CU for the CU to extract a remaining part of the RRC message. In some embodiments, the DU 532 may transmit the configuration to the UE and forward the control message to the CU. Upon receiving the control message, the CU may extract a remaining part of the RRC message from the control message. Based on the extracted remaining part of the RRC message, the CU may decide to change a configuration (such as a measurement configuration) of the UE based on the extracted remaining part of the message. When the CU changes a configuration of the UE, the process may follow the same steps as explained above for the transmission of the control message from the CU to the UE.

Therefore, the provision of a RRC functions in a DU can reduce latency in communications for controlling a communications device compared with conventional architectures as explained above. Furthermore, the CU-CP 514 may execute the RRM-1 functions 502 and the DU 532 may execute the RRM-2 functions 520. The execution of the RRM functions 502. 520 may impact the contents of the RRC message based on, for example, an interference management/communications resource management decision. Furthermore, the CU-CP 514 may execute the Security-1 functions 506 and the DU 532 may execute the Security-2 functions 524 to provide for a secure transmission of the RRC message.

As will be explained in more detail with reference to FIG. 7. example embodiments can provide an architecture for exchanging interference management information between a plurality of DUs which are configured to perform the gNB functions described in FIG. 6.

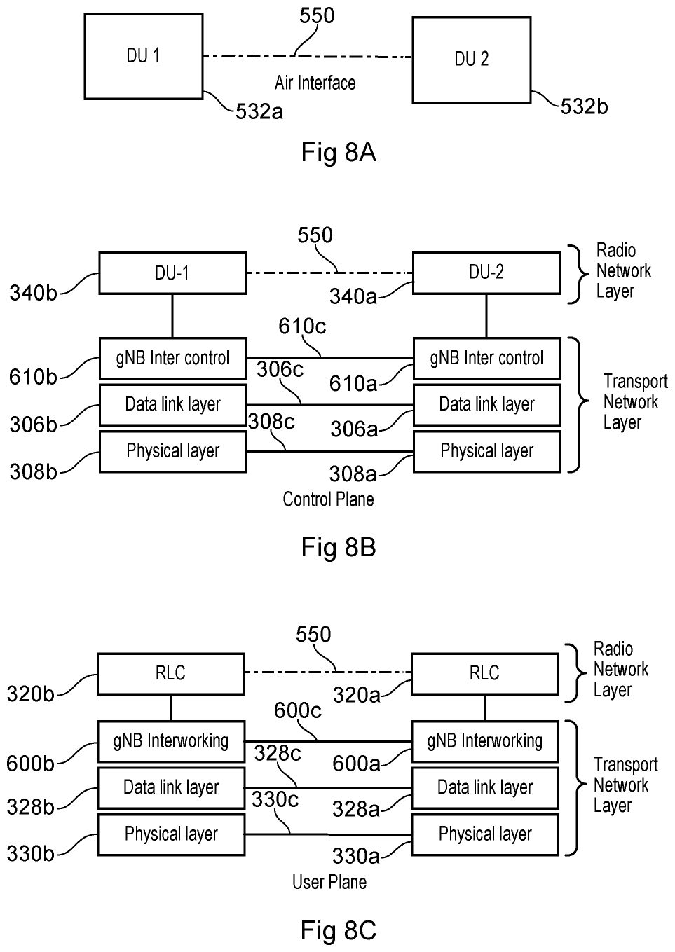

FIG. 7 schematically illustrates an improved allocation of gNB functions in a CU and a DU for a plurality of communications devices according to example embodiments. FIG. 7 illustrates a set of functions for a first communications device 540 in the CU-CP 514, the CU-UP 518 and a first DU 532a. Furthermore, FIG. 7 illustrates a set of functions for a second communications device 542 in the CU-CP 514, the CU-UP 518 and a second DU 532b. The set of functions performed by the first DU 532a and the second DU 532b broadly correspond to the set of functions performed by the DU 532 described in FIG. 6. The set of functions performed the CU-CP 514 for the first communications device 540 and for the second communications device 542 broadly correspond to the set of functions performed by the CU-CP 514 described in FIG. 6. The PDCP-UP functions 516 performed by the CU-UP 518 for the first communications device and for the second communications device 542 may broadly correspond to the PDCP-UP functions performed by the CU-UP 518 described in FIG. 6. The first DU 540 and the second DU 542 may be physically separate nodes. In accordance with example embodiments, there is provided between the first DU 532a and the second DU 532b an air interface 550 configured for the exchange of information for interference management. The air interface 500 is explained in more detail with reference to FIGS. 8A, 8B and 8C below. The air interface may utilise communications resources of the physical layer. In other words, communications resources are shared between the first communications device 540, the second communications device 542, the first DU 532a and the second DU 532b. The first communications device 540 is located in a cell provided by the first DU 532a and the second communications device is located in a cell provided by the second DU 532b. In other words, the first DU 532a is configured to control the first communications device 540 and the second DU 532b is configured to control the second communications device 532b. Therefore, if any communications resource management is required to manage inter-cell interference between the cell containing the first communications device 540 and the cell containing the second communications device 542, such information can be exchanged over the air interface 550 between the first DU 532a and the second DU 532b. In the example shown in FIG. 7, the first DU 532a and the second DU 532a are physically separate nodes. Therefore the air interface 550 may be referred to as a “physical DU-DU interface”. Alternatively, due to the presence of the RRM-2 functions 520, the RRC-2 functions 522 and the Security functions 524 in the first DU 532a and the second DU 532b, the air interface 550 may be referred to as a “logical CU-CU interface”. In other words, the air interface 550 may be regarded as a logical CU-CU interface due to the presence of CU functions in the first DU 532a and the second DU 532b.

The configuration described in FIG. 7 can improve interference management, particularly in the context of dense cell deployment. For example, the RRM-2 functions 522 may include measurement and reporting functions. Accordingly, the first DU 532a and the second DU 532b may utilise the RRM-2 functions 520 to respectively collect a measurement report from the first communications device 540 and the second communications device 542 respectively. Then, by exchanging information about the measurement reports over the air interface 550, the first DU 532a and the second DU 532b can determine whether additional measurement configurations are required for interference management and in addition if any action is required based on received measurement reports. If the first DU 532a and the second DU 532b determine that additional measurement configurations are required for interference management, then the first DU 532a and the second DU 532b may each send an updated measurement configuration to the first communications device 540 and the second communications device 542 respectively. Furthermore, also in response to determining that additional measurement configurations are required for interference management, the first DU 532a and the second DU 532b may each send a measurement result to the CU-CP 540.

Example embodiments can be adapted to provide hybrid interference management which comprises a mix of centralised interference management and distributed interference management. For example, centralised interference management (where interference management decisions are taken by the CU-CP 540) may be utilised for long-term interference management whereas distributed interference management (where interference management decisions are taken by the DUs 532a, 532b) may be utilised for short-term interference management. Therefore, distributed interference management can provide rapid feedback on short-term interference decisions.

In one such embodiment, the measurement result described above is only sent to the CU-CP 540 if long-term measurement configuration updates are required.

Therefore. example embodiments can provide a means for DUs to directly exchange information regarding interference management between different cells over the air. The information regarding interference management may include, for example, information regarding coordination of resource allocations, power controls measurement reports and the like as will be appreciated by one skilled in the art. Furthermore, the interference management information may include instructions for adjusting communications in the time, frequency and/or spatial domain to reduce inter-cell interference. Furthermore, since the interface between the DUs is an air interface. latency can be reduced. The provision of such an air interface can solve the problem of increased latency caused by the arrangement of DUs and CUs in a tree topology as discussed above.

As indicated above, the allocation of CU functions to a DU can reduce the number of round trip iterations between CUs and DUs required to control communications with a communications device. For example, an RRC message may be partly filled by a CU and partly filled by a DU instead of the CU collecting information from the DU first and then filling the same information in the RRC message.

As mentioned previously, dense cell deployment scenarios typically utilise a higher bandwidth which means smaller cell sizes but increased communications resources are available. Since the cell size is small, there is usually excess communications resources in dense cell deployment scenarios. In accordance with example embodiments, such excess communications resources can be utilised for communications over the air interface between the DUs. Therefore, communications resources can be efficiently utilised.

The provision of the air interface furthermore allows for the design of a new network interface which may benefit from the removal of legacy protocol stacks such as IP.

Furthermore, provision of the air interface between DUs may allow for information exchange between a private network CU/DU and a public network CU/DU. Currently, information exchange between a private network CU/DU and a public network CU/DU is only possible with an ideal backhaul connection which is unlikely to occur in practice. Therefore, the provision of the air interface between DUs may allow for information exchange between a private network CU/DU and a public network CU/DU without requiring an ideal backhaul connection.

Example embodiments can also utilise a blockchain method for information exchange over the air interface between the DUs, and between the DUs and CU, to provide secure communications over the air interface. The implementation of the blockchain method can be provided by the Security-2 functions 624.

In accordance with some example embodiments, the above technical advantages can be achieved without requiring an adaptation to the current operation of UEs. This means that legacy UEs can operate in networks which utilise the air interface between DUs. In other example embodiments which are not transparent to the UE (i.e. new UE behaviour required), the air interface may be designed based on RRC containers (similar to F1-AP in NR). In such embodiments, there may be implicit impacts to current UE operation. For example, if the first DU utilises the Security-2 functions 524 to perform encryption on a message, and the CU-CP 514 utilises the Security-1 functions 506 to perform a different encryption on a different part of the same message, then the UE should be aware of the different security architectures for the CU-CP 514 and the DU 532a.

As illustrated in FIGS. 8A. 8B and 8C, the air interface 550 can be provided by adapting the protocol stack shown in FIGS. 3A. 3B and 3C. In FIG. 8A, the first DU 532a and the second DU 532b are shown to be connected by the air interface 550. In FIG. 8B and FIG. 8C a protocol stack is shown for the control plane and user plane data respectively. The protocol stacks for the user plane and the control plane of FIGS. 8C and 8B correspond respectively to those shown in FIGS. 3C and 3B, and so only the differences with respect to those established protocol stacks will be described for brevity and conciseness. As shown in FIG. 8C the user plane protocol stack includes a gNB interworking layer 600a, 600b, 600c which is on top of the data link layer 328a, 328b, 328c and the physical layer 330a, 330b, 330c. In accordance with example embodiments, the gNB interworking 600b layer can enable peer-to-peer communication between DUs including multi-hop communication. In multi-hop communication, an air interface, such as air interface 550, may be formed between more than two DUs in a chain. For example, a first air interface may be formed between a first DU and a second DU, and a second air interface may be formed between the second DU and a third DU and so on. The gNB interworking 600b layer may enable peer-to-peer communication over the air interfaces between the DUs. The RLC service data units (SDU) are therefore transmitted by the gNB interworking layer, which replaces the GTP-U layer 322a, 322b, 322c, the UDP layer 324a, 324b, 324c and the IP layer 326a, 326b, 326c shown in FIG. 3C. The user plane data is therefore being transmitted as RLC SDUs via the protocol stack shown in FIG. 8C in which the gNB interworking layer 600 is used to transmit data received from the RRC layer between the first DU 532a and the second DU 532b. Correspondingly, the control plane shown in FIG. 8B provides a control plane layer for the gNB interworking control layer 610a, 610b, 610c which controls the user plane gNB interworking layer to control transmission of the user plane data under influence of a DU-DU layer 340a, 340b, 500 via the data link layer 306a, 306b, 306c and physical layers 308a, 308b, 308c. In some embodiments, the physical layers 308a, 308b, 308c are cellular physical layers which are shared with communications devices.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique;

Paragraph 1. A method of controlling a distributed unit, DU, connected to a central unit, CU, of a wireless communications network, the method comprising
receiving, from another DU connected to the CU, information for controlling communications with a communications device controlled by the DU, the information for controlling communications with the communications device being received over an air interface connecting the DU and the other DU, and
controlling communications with the communications device based on the information for controlling communications with the communications device received over the air interface, wherein the controlling the communications with the communications device comprises
executing one or more control functions including at least a radio resource management, RRM, function.
   Paragraph 2. A method according to paragraph 1, wherein the executing the one or more control functions comprises executing a radio resource control, RRC, function.
   Paragraph 3. A method according to paragraph 1 or paragraph 2, wherein the executing the one or more control functions comprises executing a security function.
   Paragraph 4. A method according to any of paragraphs 1 to 3, wherein the information for controlling communications with the communications device comprises
an indication of communications resources allocated for communications with one or more other communications devices controlled by the other DU, and the controlling communications with the communications device based on the information for controlling communications with the communications device comprises
determining a communications resource allocation for communications with the communications device based on the indication of the communications resources allocated for communications with the one or more other communications devices.
   Paragraph 5. A method according to any of paragraphs 1 to 4, wherein the information for controlling communications with the communications device comprises
an indication of a transmission power used for transmissions to, or transmissions by, the one or more other communications devices controlled by the other DU, and the controlling communications with the communications device based on the information for controlling communications with the communications device comprises
determining a transmission power to be used for transmissions to, or transmissions by, the communications device based on the indication of the transmission power used for transmissions to, or transmissions by, from the one or more other communications devices.
   Paragraph 6. A method according to any of paragraphs 1 to 5, wherein the one or more control functions executed by the DU are secondary control functions corresponding to one or more master control functions configured to be executed by the CU, the method comprising
receiving information for executing the secondary control functions from the CU, wherein the executing the one or more control functions comprises
executing the one or more control functions based on the information received from the CU.
   Paragraph 7. A method according to paragraph 6, wherein the secondary control functions are a subset of the master control functions.
   Paragraph 8. A method according to any of paragraphs 1 to 7, wherein the controlling communications with the communications device based on the information for controlling communications with the communications device received over the air interface comprises
receiving a measurement report from the communications device,
determining whether an additional measurement configuration is required for the communications device based on the measurement report, the determining including executing Radio Resource Control, RRC, functions based on the measurement report, and, if an additional measurement configuration is required for the communications device,
preparing and transmitting the additional measurement configuration to the communications device.
   Paragraph 9. A method according to paragraph 8, wherein the determining whether an additional measurement configuration is required for the communications device based on the measurement report comprises
determining whether an additional measurement configuration is required for the communications device based on the measurement report and the information for controlling the communications device received over the air interface.
   Paragraph 10. A method according to any of paragraphs 1 to 9, wherein the air interface connecting the DU and the other DU utilises licensed communications resources.
   Paragraph 11. A method according to any of paragraphs 1 to 10, wherein the information for controlling communications with the communications device is received from the other DU according to a blockchain format.
   Paragraph 12. A method according to any of paragraphs 1 to 11, wherein the DU belongs to a private network and the other DU belongs to a public network or the DU belongs to the public network and the other DU belongs to the private network.
   Paragraph 13. A method of controlling a distributed unit, DU, connected to a central unit, CU, of a wireless communications network, the method comprising
receiving a control message from CU, the control message including a part of a radio resource control, RRC, message for transmission to a communications device.
executing an RRC function based on the control message to include a remaining part of the RRC message in the control message, wherein the part of the RRC message in the control message received from the CU and the remaining part of the RRC message included by the DU in the control message form a completed RRC message in the control message, and
forwarding the control message including the completed RRC message to the communications device.
   Paragraph 14. A method according to paragraph 13, comprising executing Radio Resource Management. RRM, functions based on the control message received from the central unit,
   Paragraph 15. A method according to paragraph 13 or paragraph 14, comprising executing security functions based on the control message received from the central unit.
   Paragraph 16. A method according to any of paragraphs 13 to 15, wherein the completed RRC message includes an indication of measurement configuration for the communications device.
   Paragraph 17. A method of controlling a distributed unit, DU, connected to a central unit, CU, of a wireless communications network, the method comprising
receiving, from a communications device controlled by the DU, a control message including a Radio Resource Control, RRC, message,
executing an RRC function based on the control message to extract a part of the RRC message from the control message, and
forwarding the control message to the CU for the CU to extract a remaining part of the RRC message from the control message.
   Paragraph 18. A method according to paragraph 17, comprising
executing a Radio Resource management, RRM, function based on the control message received from the communications device.
   Paragraph 19. A method according to paragraph 17 or paragraph 18, comprising
executing a security function based on the control message received from the communications device.
   Paragraph 20. A method according to any of paragraphs 17 to 19, wherein the RRC message received from the communications device includes an indication of a measurement report.
   Paragraph 21. A method according to paragraph 20, comprising
transmitting a measurement configuration to the communications device based on the measurement report.
   Paragraph 22. A distributed unit, DU, connected to a central unit, CU, of a wireless communications network, the DU comprising
a transmitter configured to transmit signals,
a receiver configured to receive signals,
a controller configured in combination with the transmitter and the receiver to
receive, from another DU connected to the CU, information for controlling communications with a communications device controlled by the DU, the information for controlling communications with the communications device being received over an air interface connecting the DU and the other DU, and
control communications with the communications device based on the information for controlling communications with the communications device received over the air interface by executing one or more control functions including at least a radio resource management, RRM, function.
   Paragraph 23. A DU according to paragraph 22, wherein the controller configured in combination with the transmitter and the receiver to control communications with the communications device based on the information for controlling communications with the communications device received over the air interface by executing a radio resource control, RRC, function.
   Paragraph 24. A DU according to paragraph 22 or paragraph 23, wherein the controller configured in combination with the transmitter and the receiver to control communications with the communications device based on the information for controlling communications with the communications device received over the air interface by executing a security function.
   Paragraph 25. A DU according to any of paragraphs 22 to 24, wherein the information for controlling communications with the communications device comprises
an indication of communications resources allocated for communications with one or more other communications devices controlled by the other DU, wherein the controller configured in combination with the transmitter and the receiver to
determine a communications resource allocation for communications with the communications device based on the indication of the communications resources allocated for communications with the one or more other communications devices.
   Paragraph 26. A DU according to any of paragraphs 22 to 25, wherein the information for controlling communications with the communications device comprises
an indication of a transmission power used for transmissions to, or transmissions by, the one or more other communications devices controlled by the other DU, wherein the controller configured in combination with the transmitter and the receiver to
determine a transmission power to be used for transmissions to, or transmissions by, the communications device based on the indication of the transmission power used for transmissions to, or transmissions by, from the one or more other communications devices.
   Paragraph 27. A DU according to any of paragraphs 22 to 26, wherein the one or more control functions executed by the DU are secondary control functions corresponding to one or more master control functions configured to be executed by the CU, wherein the controller configured in combination with the transmitter and the receiver to
receive information for executing the secondary control functions from the CU, and
execute the one or more control functions based on the information received from the CU.
   Paragraph 28. A DU according to paragraph 27, wherein the secondary control functions are a subset of the master control functions.
   Paragraph 29. A DU according to any of paragraphs 22 to 28, wherein the controller configured in combination with the transmitter and the receiver to
receive a measurement report from the communications device.
determine whether an additional measurement configuration is required for the communications device based on the measurement report, the determining including executing a Radio Resource Control, RRC, function based on the measurement report, and, if an additional measurement configuration is required for the communications device, and the controller configured in combination with the transmitter and the receiver to
prepare and transmit the additional measurement configuration to the communications device.
   Paragraph 30. A DU according to paragraph 29, wherein the controller configured in combination with the transmitter and the receiver to
determine whether an additional measurement configuration is required for the communications device based on the measurement report and the information for controlling the communications device received over the air interface.
   Paragraph 31. A DU according to any of paragraphs 22 to 29, wherein the air interface connecting the DU and the other DU utilises licensed communications resources.
   Paragraph 32. A DU according to any of paragraphs 22 to 31, wherein the information for controlling communications with the communications device is received from the other DU according to a blockchain format.
   Paragraph 33. A DU according to any of paragraphs 22 to 32, wherein the DU belongs to a private network and the other DU belongs to a public network or the DU belongs to the public network and the other DU belongs to the private network.
   Paragraph 34. A distributed unit, DU, connected to a central unit, CU, of a wireless communications network, the DU comprising
a transmitter configured to transmit signals.
a receiver configured to receive signals.
a controller configured in combination with the transmitter and the receiver to
receive a control message from CU, the control message including a part of a radio resource control, RRC, message for transmission to a communications device.
execute an RRC function based on the control message to include a remaining part of the RRC message in the control message, wherein the part of the RRC message in the control message received from the CU and the remaining part of the RRC message included by the DU in the control message form a completed RRC message in the control message, and
forward the control message including the completed RRC message to the communications device.
   Paragraph 35. A DU according to paragraph 34, wherein the controller is configured in combination with the transmitter and the receiver to
execute a Radio Resource Management, RRM, function based on the control message received from the central unit,
   Paragraph 36. A DU according to paragraph 34 or paragraph 35, wherein the controller is configured in combination with the transmitter and the receiver to
execute a security function based on the control message received from the central unit.
   Paragraph 37. A DU according to any of paragraphs 34 to 36, wherein the completed RRC message includes an indication of measurement configuration for the communications device.
   Paragraph 38. A distributed unit, DU, connected to a central unit, CU, of a wireless communications network, the DU comprising
a transmitter configured to transmit signals,
a receiver configured to receive signals.
a controller configured in combination with the transmitter and the receiver to
receive, from a communications device controlled by the DU, a control message including a Radio Resource Control, RRC, message,
execute an RRC function based on the control message to extract a part of the RRC message from the control message, and
forward the control message to the CU for the CU to extract a remaining part of the RRC message from the control message.
   Paragraph 39. A DU according to paragraph 38, wherein the controller is configured in combination with the transmitter and the receiver to
execute a Radio Resource management. RRM, function based on the control message received from the communications device.
   Paragraph 40. A DU according to paragraph 38 or paragraph 39, wherein the controller is configured in combination with the transmitter and the receiver to
execute a security function based on the control message received from the communications device.
   Paragraph 41. A DU according to any of paragraphs 38 to 40, wherein the RRC message received from the communications device includes an indication of a measurement report.
   Paragraph 42. A DU according to paragraph 41, wherein the controller is configured in combination with the transmitter and the receiver to
transmit a measurement configuration to the communications device based on the measurement report.
   Paragraph 43. Circuitry for a distributed unit, DU, connected to a central unit, CU, of a wireless communications network, the circuitry comprising
transmitter circuitry configured to transmit signals,
receiver circuitry configured to receive signals,
controller circuitry configured in combination with the transmitter circuitry and the receiver circuitry to
receive, from another DU connected to the CU, information for controlling communications with a communications device controlled by the DU, the information for controlling communications with the communications device being received over an air interface connecting the DU and the other DU, and
control communications with the communications device based on the information for controlling communications with the communications device received over the air interface by executing one or more control functions including at least a radio resource management. RRM, function.
   Paragraph 44. Circuitry for a distributed unit, DU, connected to a central unit, CU, of a wireless communications network, the circuitry comprising
transmitter circuitry configured to transmit signals,
receiver circuitry configured to receive signals,
controller circuitry configured in combination with the transmitter circuitry and the receiver circuitry to
receive a control message from CU, the control message including a part of a radio resource control, RRC, message for transmission to a communications device,
execute an RRC function based on the control message to include a remaining part of the RRC message in the control message, wherein the part of the RRC message in the control message received from the CU and the remaining part of the RRC message included by the DU in the control message form a completed RRC message in the control message, and
forward the control message including the completed RRC message to the communications device.
   Paragraph 45. Circuitry for a distributed unit, DU, connected to a central unit, CU, of a wireless communications network, the circuitry comprising
transmitter circuitry configured to transmit signals,
receiver circuitry configured to receive signals,
controller circuitry configured in combination with the transmitter circuitry and the receiver circuitry to
receive, from a communications device controlled by the DU, a control message including a Radio Resource Control, RRC, message,
execute an RRC function based on the control message to extract a part of the RRC message from the control message, and
forward the control message to the CU for the CU to extract a remaining part of the RRC message from the control message.
   Paragraph 46. A computer program comprising instructions which, when loaded onto a computer, cause the computer to perform a method according to any of paragraphs 1 to 21.
   Paragraph 47. A non-transitory computer-readable storage medium storing a computer program according to paragraph 46.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### References

[1] 3GPP document, TS 38.470.
[2] 3GPP document TS 38.473.
[3] 3GPP document TS 38.401.
[4] 3GPP document TS 138 472-V15.2.0.
[5] 3GPP document TS38.300.
[6] 3GPP document TS 23.501.
[7] 3GPP document TS 36.300.
[8] Berardinelli et al, “Extreme communication in 6G, Vision and Challenges for ‘in-X’ Subnetworks”.

1. A method of controlling a distributed unit, DU, connected to a central unit, CU, of a wireless communications network, the method comprising
receiving, from another DU connected to the CU, information for controlling communications with a communications device controlled by the DU, the information for controlling communications with the communications device being received over an air interface connecting the DU and the other DU, and
controlling communications with the communications device based on the information for controlling communications with the communications device received over the air interface, wherein the controlling the communications with the communications device comprises
executing one or more control functions including at least a radio resource management, RRM, function.

2. A method according to claim 1, wherein the executing the one or more control functions comprises executing a radio resource control, RRC, function.

3. A method according to claim 1, wherein the executing the one or more control functions comprises executing a security function.

4. A method according to claim 1, wherein the information for controlling communications with the communications device comprises
an indication of communications resources allocated for communications with one or more other communications devices controlled by the other DU, and the controlling communications with the communications device based on the information for controlling communications with the communications device comprises
determining a communications resource allocation for communications with the communications device based on the indication of the communications resources allocated for communications with the one or more other communications devices.

5. A method according to claim 1, wherein the information for controlling communications with the communications device comprises
an indication of a transmission power used for transmissions to, or transmissions by, the one or more other communications devices controlled by the other DU, and the controlling communications with the communications device based on the information for controlling communications with the communications device comprises
determining a transmission power to be used for transmissions to, or transmissions by, the communications device based on the indication of the transmission power used for transmissions to, or transmissions by, from the one or more other communications devices.

6. A method according to claim 1, wherein the one or more control functions executed by the DU are secondary control functions corresponding to one or more master control functions configured to be executed by the CU, the method comprising
receiving information for executing the secondary control functions from the CU, wherein the executing the one or more control functions comprises
executing the one or more control functions based on the information received from the CU.

7. A method according to claim 6, wherein the secondary control functions are a subset of the master control functions.

8. A method according to claim 1, wherein the controlling communications with the communications device based on the information for controlling communications with the communications device received over the air interface comprises
receiving a measurement report from the communications device,
determining whether an additional measurement configuration is required for the communications device based on the measurement report, the determining including executing Radio Resource Control, RRC, functions based on the measurement report, and, if an additional measurement configuration is required for the communications device,
preparing and transmitting the additional measurement configuration to the communications device.

9. A method according to claim 8, wherein the determining whether an additional measurement configuration is required for the communications device based on the measurement report comprises
determining whether an additional measurement configuration is required for the communications device based on the measurement report and the information for controlling the communications device received over the air interface.

10. A method according to claim 1, wherein the air interface connecting the DU and the other DU utilises licensed communications resources.

11. A method according to claim 1, wherein the information for controlling communications with the communications device is received from the other DU according to a blockchain format.

12. A method according to claim 1, wherein the DU belongs to a private network and the other DU belongs to a public network or the DU belongs to the public network and the other DU belongs to the private network.

13. A method of controlling a distributed unit, DU, connected to a central unit, CU, of a wireless communications network, the method comprising
receiving a control message from CU, the control message including a part of a radio resource control, RRC, message for transmission to a communications device,
executing an RRC function based on the control message to include a remaining part of the RRC message in the control message, wherein the part of the RRC message in the control message received from the CU and the remaining part of the RRC message included by the DU in the control message form a completed RRC message in the control message, and
forwarding the control message including the completed RRC message to the communications device.

14. A method according to claim 13, comprising
executing Radio Resource Management, RRM, functions based on the control message received from the central unit,

15. A method according to claim 13, comprising
executing security functions based on the control message received from the central unit,

16. A method according to claim 13, wherein the completed RRC message includes an indication of measurement configuration for the communications device.

17-42. (canceled)

43. Circuitry for a distributed unit, DU, connected to a central unit, CU, of a wireless communications network, the circuitry comprising
transmitter circuitry configured to transmit signals,
receiver circuitry configured to receive signals,
controller circuitry configured in combination with the transmitter circuitry and the receiver circuitry to
receive, from another DU connected to the CU, information for controlling communications with a communications device controlled by the DU, the information for controlling communications with the communications device being received over an air interface connecting the DU and the other DU, and
control communications with the communications device based on the information for controlling communications with the communications device received over the air interface by executing one or more control functions including at least a radio resource management, RRM, function.

44. Circuitry for a distributed unit, DU, connected to a central unit, CU, of a wireless communications network, the circuitry comprising
transmitter circuitry configured to transmit signals,
receiver circuitry configured to receive signals,
controller circuitry configured in combination with the transmitter circuitry and the receiver circuitry to
receive a control message from CU, the control message including a part of a radio resource control, RRC, message for transmission to a communications device,
execute an RRC function based on the control message to include a remaining part of the RRC message in the control message, wherein the part of the RRC message in the control message received from the CU and the remaining part of the RRC message included by the DU in the control message form a completed RRC message in the control message, and
forward the control message including the completed RRC message to the communications device.

45-47. (canceled)
